(19) United States
(12) Patent Application Publication
(10) Pub. No.: US 2018/0123902 A1
(43) Pub. Date: May 3, 2018

(54) METHOD OF OPERATING A SENSOR NETWORK AND SYSTEM THEREFOR

(71) Applicant: AGT INTERNATIONAL GMBH, Zurich (CH)

(72) Inventors: Manuel GOERTZ, Reinheim (DE); Alexander WIESMAIER, Ober-Ramstadt (DE); Evangelos GAZIS, Darmstadt (DE)

(21) Appl. No.: 15/339,237

(22) Filed: Oct. 31, 2016

(51) Int. Cl. H04L 12/24; H04L 29/08

(52) U.S. Cl. CPC H04L 41/147; H04L 67/12

(57) ABSTRACT

A method of operating a sensor network including a plurality of sensors and one or more control stations. The method includes generating by a processor-based device operatively connected to the at least one sensor from among the plurality of sensors, one or more concurrent predicted requests. Each predicted request specifies parameters related to output data predicted to be requested by the one or more control stations and related to the captured data, selecting a utility from among multiple predefined utilities stored in a memory of the device, the utility being selected based, at least, on the one or more parameters specified in the generated predicted request, and using the selected utility to process data captured by the at least one sensor, thereby giving rise to predicted output data usable by an incoming request from the one or more control stations when the incoming request corresponds to the predicted request.

### TECHNICAL FIELD

The presently disclosed subject matter relates to operating sensor networks and, in particular, to systems and methods of processing and storing data in sensor networks.

### BACKGROUND

An increasing amount of sensor networks are being installed on a global scale. Applications of sensor networks include traffic control, traffic surveillance, video surveillance, industrial and manufacturing automation, distributed robotics, environment monitoring, and building and structure monitoring, etc. These sensor networks comprise a multitude of different sensors located at a plurality of sensor nodes for capturing data relevant to respective applications. Sensors in sensor networks can be active and/or passive, stationary and/or mobile, dumb and/or smart, etc. Sensor networks can be homogeneous with the same type of sensors, or heterogeneous with the different types of sensors.

Typical prior art sensor networks have a centralized architecture with sensor nodes passing the captured data to processing and storing capacities located at a backend of the sensor network. Captured data can be passed to the backend capacities directly or via one or more special gateways capable of caching the captured data. Sensor nodes can be configured as “dump” data sources or, optionally, can be configured as smart sensor nodes enabling offloading processing and storing capacities of the backend of the sensor network. Smart sensor nodes comprise processing capabilities (operatively connected or integrated with respective sensors) configured to provide predetermined pre-processing of the captured data before sending to the backend.

### General Description

Smart sensor nodes known in the art can enable decreasing the amount of data that needs to be sent to the backend of the system, and, potentially alleviate the processing load of the backend. By way of non-limiting example, a sensor node can be predetermined to pre-process a captured video stream to perform a face detection. In such a case, instead of sending the entire video stream to the backend capacities, the camera, upon detecting a face, can clip the relevant frames and transmit them to the backend. However, the predetermined pre-processing capabilities of prior art sensor nodes are static and thereby involve processing and transferring of irrelevant data, e.g., still doing face detection while license plate recognition would be needed. However, the processing capabilities in accordance with certain examples of the sensor nodes of the presently disclosed subject matter are dynamic and thereby involve processing and transferring data determined to be relevant, e.g. doing face recognition when face recognition data is determined to be relevant and switching to license plate recognition when license plate recognition data is determined to be relevant. As such, in accordance with certain examples of the presently disclosed subject matter, there are also provided technique(s) enabling flexible generation of output data in response to a predicted and/or received request(s).

According to one aspect of the presently disclosed subject matter there is provided a method of operating a sensor network. The sensor network includes a plurality of sensor nodes and at least one control station. Each sensor node includes a memory operatively connected to a processor and to at least one sensor. The method includes generating, by a sensor node from among the plurality of sensor nodes, a predicted request specifying at least one parameter corresponding to predicted output data. The method further includes using, by the sensor node, the generated predicted request to select at least one utility from among a plurality of predefined utilities. The selected utility is configured to execute at least one of predefined functions selected from the group consisting of: functions related to obtaining, by the sensor node, sensor data usable to generate predicted output data, functions related to processing, by the sensor node, sensor data to generate predicted output data, and functions related to buffering at the sensor node generated predicted output data. The method further includes using, by the sensor node, the selected at least one utility to generate predicted output data, thereby giving rise to predicted output data usable by an incoming request from the at least one control station when the incoming request corresponds to the predicted request.

In addition to the above features, the method according to this aspect of the presently disclosed subject matter can include one or more of features (i) to (vii) listed below, in any desired combination or permutation which is technically possible:
(i). wherein the at least one parameter of the predicted request is selected from the group consisting of: data indicative of a priority ranking of the predicted request; data indicative of predicted output data; and data indicative of the destination of the output data generated in accordance with the predicted request.
(ii). wherein the predicted request is generated using data selected from a group consisting of data informative of: historical data corresponding to a previously served incoming request; statistics of historical data corresponding to a previously served incoming request; historical data corresponding to a previously generated predicted request; statistics of historical data corresponding to a previously generated predicted request; historical data corresponding to matching between a previously generated predicted request and a respective served incoming request; statistics of historical data corresponding to matching between a previously generated predicted request and a respective served incoming request; a concurrent incoming request; context information; and at least one external parameter.
(iii). wherein generating the predicted request is provided using a request model, the request model built using at least one historic incoming request, and at least one of: context information; at least one external parameter; state of a buffer; content of a buffer; and feedback information.
(iv). wherein the request model is updated, by the sensor node, responsive to at least one of: serving at least one new incoming request; obtaining updated context information; generating at least one predicted request; serving at least one predicted request; obtaining sensor data; and obtaining feedback information.
(v). outputting, by the sensor node, predicted output data responsive to an incoming request corresponding to the predicted request.
(vi). post-processing, by the sensor node, the predicted output data according to at least one parameter of the incoming request, when the predicted request only partly corresponds to the incoming request.
(vii). wherein post-processing further comprises selecting a utility from among multiple predefined utilities based on the at least one parameter of the incoming request; and using the selected utility to post-process the predicted output data, thereby giving rise to output data specified by the incoming request.

According to another aspect of the presently disclosed subject matter there is provided a non-transitory program storage device readable by machine, tangibly embodying a program of instructions executable by the machine to perform the above method of operating a sensor network.

This aspect of the disclosed subject matter can optionally include one or more of features (i) to (vii) listed above, mutatis mutandis, in any desired combination or permutation which is technically possible.

According to another aspect of the presently disclosed subject matter there is provided a sensor node in a sensor network. The sensor network includes a plurality of sensor nodes and at least one control station. The sensor node includes a memory operatively connected to a processor and to at least one sensor. The processor is configured to generate a predicted request specifying at least one parameter corresponding to predicted output data, and, use the generated predicted request to select at least one utility from among a plurality of predefined utilities. The selected utility is configured to execute at least one of predefined functions selected from the group consisting of: functions related to obtaining, by the sensor node, sensor data usable to generate predicted output data, functions related to processing, by the sensor node, sensor data to generate predicted output data, and functions related to buffering at the sensor node generated predicted output data. The processor is further configured to use the selected at least one utility to generate predicted output data, thereby giving rise to predicted output data usable by an incoming request from the at least one control station when the incoming request corresponds to the predicted request.

This aspect of the disclosed subject matter can optionally include one or more of features (i) to (vii) listed above, mutatis mutandis, in any desired combination or permutation which is technically possible.

According to another aspect of the presently disclosed subject matter there is provided a method of operating a sensor network. The sensor network includes a plurality of sensor nodes and at least one control station. Each sensor node includes a memory operatively connected to a processor and to at least one sensor. The method includes obtaining, by the sensor node, a request specifying at least one parameter corresponding to output data, and, using, by the sensor node, the obtained request to select at least one utility. The at least one utility specifying at least one of: obtaining, by the sensor node, sensor data usable to generate output data; processing, by the sensor node, sensor data to generate output data; and buffering, at the sensor node, generated output data. The method further includes automatically reconfiguring operation of the sensor node in accordance with the selected utility.

In addition to the above features, the method according to this aspect of the presently disclosed subject matter can include one or more of features (i) to (vii) listed below, in any desired combination or permutation which is technically possible:
(i). generating, by the sensor node, at least one general specification based on at least one parameter specified in the request.
(ii). wherein the at least one general specification is generated using data selected from a group consisting of: data informative of the current mode of the sensor node; context information; at least one external parameter; state of a buffer; content of a buffer; and at least one concurrent request.
(iii). comprising generating, by the sensor node, at least one customized specification based on the at least one general specification and at least one parameter of the sensor node.
(iv). selecting, by the sensor node, at least one utility usable to reconfigure the operation of the sensor node based on the at least one customized specification.
(v). wherein the at least one utility is selected from a group consisting of: a utility for obtaining sensor data to generate output data; a utility for processing sensor data to generate output data; and a utility for buffering generated output data.
(vi). wherein the at least one utility is selected from one or more algorithms corresponding to at least one predefined function of the sensor node.
(vii). wherein the at least one parameter specified in the request is selected from the group consisting of: data indicative of a priority ranking of the request; data indicative of desired processing; data indicative of output of data corresponding to the sensor data; data indicative of validity of the request; data indicative of the source of the request; and data indicative of the destination of the output data.

According to another aspect of the presently disclosed subject matter there is provided a non-transitory program storage device readable by machine, tangibly embodying a program of instructions executable by the machine to perform the above method of operating a sensor network.

This aspect of the disclosed subject matter can optionally include one or more of features (i) to (vii) listed above, mutatis mutandis, in any desired combination or permutation which is technically possible.

According to another aspect of the presently disclosed subject matter there is provided a sensor node in a sensor network. The sensor network includes a plurality of sensor nodes and at least one control station. The sensor node includes a memory operatively connected to a processor and to at least one sensor. The processor is configured to obtain a request specifying at least one parameter corresponding to output data, and, use the obtained request to select at least one utility specifying at least one of: obtaining, by the sensor node, sensor data usable to generate output data; processing, by the sensor node, sensor data to generate output data; and buffering, at the sensor node, generated output data. The processor is further configured to automatically reconfigure operation of the sensor node in accordance with the selected utility.

This aspect of the disclosed subject matter can optionally include one or more of features (i) to (vii) listed above, mutatis mutandis, in any desired combination or permutation which is technically possible.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates a functional block diagram of a sensor network, in accordance with certain examples of the presently disclosed subject matter;

FIG. 2 illustrates a functional block diagram of a sensor node, in accordance with certain examples of the presently disclosed subject matter;

FIG. 3 illustrates a generalized flow-chart of operating a sensor node, in accordance with certain examples of the presently disclosed subject matter;

FIG. 4 illustrates a generalized flow-chart of generating a request model, in accordance with certain examples of the presently disclosed subject matter;

FIG. 5 illustrates a generalized flow-chart of generating a predicted request, in accordance with certain examples of the presently disclosed subject matter;

FIG. 6 illustrates a generalized flow-chart of serving a predicted request, in accordance with certain examples of the presently disclosed subject matter;

FIG. 7 illustrates a generalized flow-chart of using a generated predicted request for serving an incoming request, in accordance with certain examples of the presently disclosed subject matter.

FIG. 8 illustrates a generalized flow-chart of operating a sensor node, in accordance with certain examples of the presently disclosed subject matter; and

FIG. 9 illustrates a generalized flow-chart of serving a request, in accordance with certain examples of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “representing”, “generating”, “updating” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, processor and memory block 102 disclosed in the present application.

The terms “non-transitory memory” and “non-transitory storage medium” as used herein should be expansively construed to cover any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

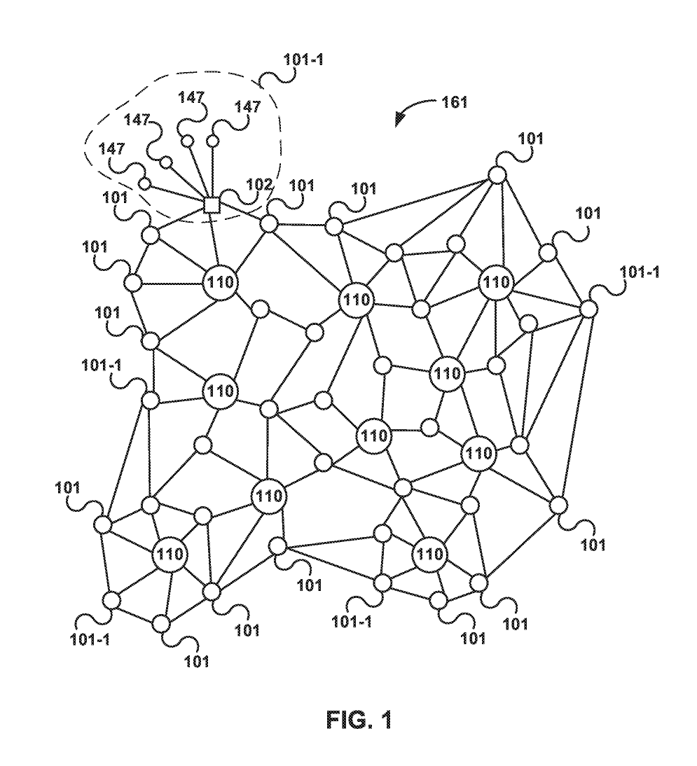

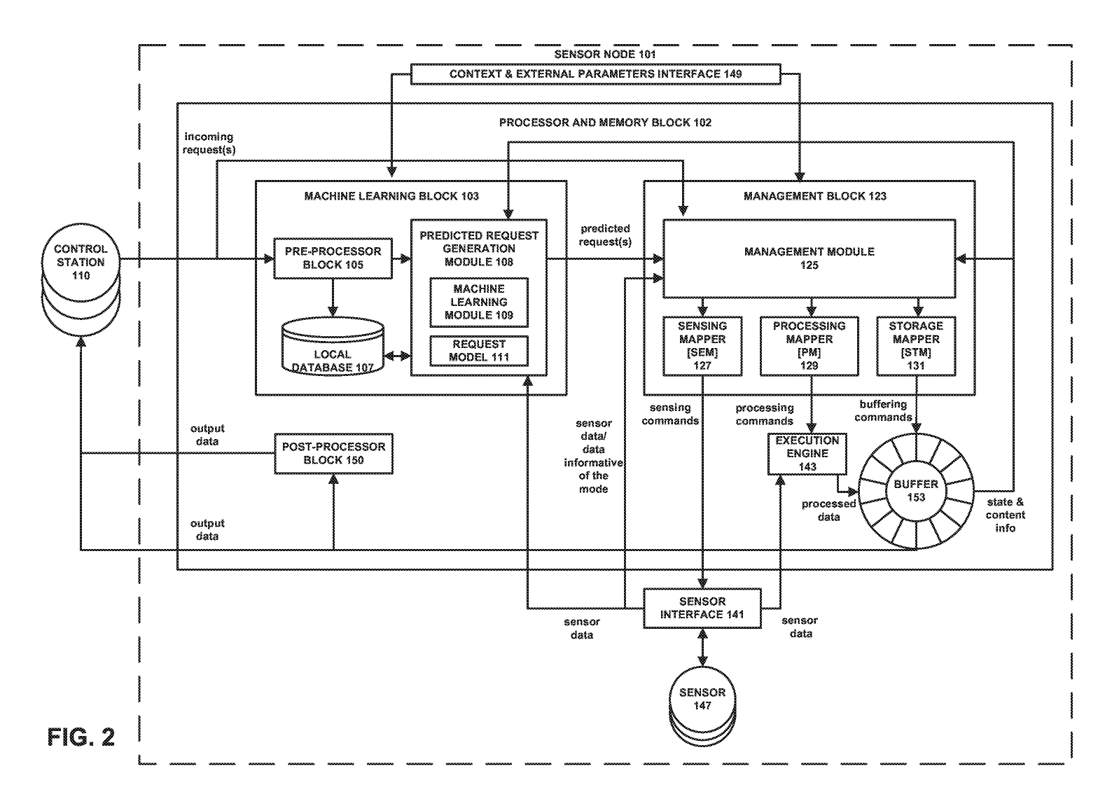

In FIG. 1 and FIG. 2 the lines connecting elements represent operative connections. The various elements connected by lines are not necessarily physically connected to each other, per se, rather they are operatively connected with one another through any appropriate means and/or manner.

Examples of the presently disclosed subject matter are not described with reference to any particular programming language. It will be appreciated that a variety of programming languages may be used to implement the teachings of the presently disclosed subject matter as described herein.

Bearing this in mind, attention is drawn to FIG. 1. FIG. 1 illustrates a functional block diagram of a sensor network 161, in accordance with certain examples of the presently disclosed subject matter.

Network 161 includes a plurality of sensor nodes 101 operatively coupled to at least one control station 110. Each sensor node 101 includes at least one sensor 147. Sensors 147 are configured to capture data informative of an environment (e.g. images, video, audio, etc.) and, optionally, to pre-process the captured data before outputting.

The term “sensor data” used in this patent specification should be expansively construed to cover any kind of data outputted from respective sensor(s) and includes data captured by the sensor(s) and/or derivatives of the captured data resulting from pre-processing provided by the sensor(s).

In accordance with certain examples of the presently disclosed subject matter, at least some of sensor nodes (designated as sensor nodes 101-1) further include a processing and memory block 102 operatively coupled to the sensors 147 of a respective node 101-1.

It is noted that in the following description, unless specifically stated otherwise, the term “sensor node 101” is equivalently used with the term “sensor node 101-1”.

As will be further detailed with reference to FIGS. 2-9, each sensor node 101 is configured to receive from a control station 110 incoming requests specifying desired output data corresponding to sensor data. Each sensor node 101 is further configured to provide the desired output data in response. The desired output data can be generated in response to a specification received in an incoming request or can be generated in advance in accordance with a predicted request.

Output data specified by an incoming request is also referred to hereinafter as “desired output data”. Output data predicted to be desired by an incoming request is also referred to hereinafter as “predicted output data”.

Sensor node 101 is capable of obtaining sensor data, and/or, of processing the obtained sensor data in multiple predefined modes. Sensor node 101 is configured to select the mode of generating output data in accordance with incoming, and/or, predicted requests. Likewise, sensor node 101 is configured to select a mode of storing the generated output data in accordance with the respective requests.

FIG. 2 illustrates a functional block diagram of a sensor node 101, in accordance with certain examples of the presently disclosed subject matter. Sensor node 101 can be part of network 161 described above.

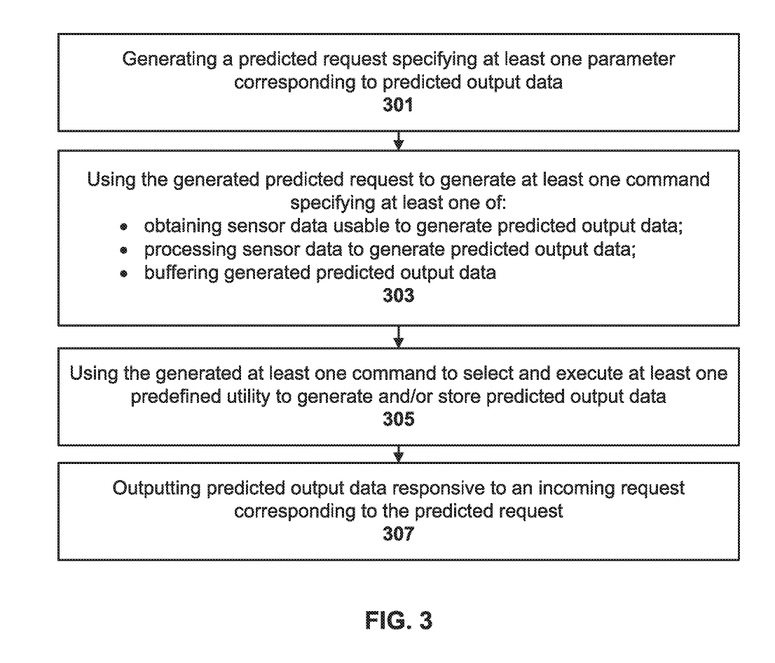

As will be further detailed with reference to FIGS. 3-9, sensor node 101 is configured to use sensor data to generate output data. In FIG. 2, sensor(s) 147 are illustrated as being operatively connected to processor and memory block 102 via a sensor interface 141.

Sensor interface 141 is configured to control the collection of sensor data. Sensor interface 141 can include switching capabilities to change at least one configuration of sensor(s) 147 based on instructions receivable from processor and memory block 102. Likewise, sensor interface 141 can be configured to, based on command(s) from processor and memory block 102, select, from among connected sensors 147, at least one sensor 147 to be the source of sensor data for further processing, and/or, selectively filter the sensor data received from sensor(s) 147.

Sensor node 101 also includes a buffer 153 configured to store data. Buffer 153 can have buffering capabilities that determine how data is stored and/or deleted, e.g. when the buffer is full.

Processor and memory block 102 is configured to execute multiple sets of executable instructions (programmable and/or hard-coded) referred to hereinafter as “utilities”. The term “utility” should be expansively construed to cover any kind of a set of executable instructions (implemented on non-transitory computer-readable storage medium in a case of programmable instructions) and configured to execute at least one predefined function when running on the processor.

Predefined functions include processing sensor data in accordance with at least one predefined algorithm, configuring sensors and/or pre-processing thereof, configuring buffering of output data, etc.

By way of non-limiting example, predefined functions related to configuring sensors and/or pre-processing thereof can include: black and white video; color video; infrared video; high resolution video; low resolution video; stereo audio; mono audio; etc. These predefined functions can correspond to software and/or hardware configurations of at least one sensor 147 of sensor node 101, e.g. different lenses or sensors (camera or microphone), different pre-processing functions, different sensors selected to provide sensor data, etc.

Predefined functions related to processing sensor data can include: face recognition, license plate recognition, image cropping, etc.

Predefined functions related to buffering output data can include: delete oldest data, delete least requested type of data, delete least general data (e.g., delete cropped faces but keep full frames), first in first out (FIFO), last in first out (LIFO), etc.

Sensor node 101 is configured to receive incoming requests for desired output data, which are sent by network 161. In FIG. 2, incoming requests are illustrated as being received from control stations 110. Alternatively or additionally, the incoming requests can be received from other elements in network 161, e.g. at least one other sensor node 101.

Sensor node 101 is further configured to output data to network 161. In FIG. 2, output data is illustrated as being output to control stations 110. Alternatively or additionally, the output data can be output to other elements in network 161, e.g. at least one other sensor node 101.

Each incoming request specifies at least one parameter corresponding to desired output data. The at least one parameter specified in the incoming request can be, for example: data indicative of a priority ranking of the request; data indicative of desired processing and/or output of data corresponding to the sensor data; data indicative of validity of the request; data indicative of the source of the request (e.g. which control station 110 the request was received from); data indicative of the destination of the output data (for example, if the destination of the output data is different from the source of the incoming request); and/or other parameters corresponding to desired output data.

Processor and memory block 102 is further configured to automatically reconfigure operation of sensor node 101 based on at least one parameter specified in the incoming request. Reconfiguring can include, for example: selecting a utility from among the multiple predefined utilities stored in a memory of the sensor node 101 for processing sensor data, configuring at least one sensor, and/or configuring buffering operations.

Further, in accordance with certain examples of the presently disclosed subject matter, processor and memory block 102 is configured to generate predicted requests.

A predicted request can be generated using data informative of, for example: historical data (and/or statistics thereof) corresponding to previously served incoming request(s); historical data (and/or statistics thereof) corresponding to previously generated predicted request(s); historical data (and/or statistics thereof) corresponding to matching between previously generated predicted requests and respective served incoming requests; a concurrent incoming request; context information; at least one external parameter(s) (e.g. system parameters and configuration); etc.

In some examples, predicted requests can be generated independently of incoming requests, e.g. relying only on context, parameters, sensed data, etc. For example, predicted requests can be generated in accordance with predefined rules corresponding to a content of sensor data (whenever a person is in the image, do face recognition; whenever a licence plate is in the image, do license plate recognition; in any case, count the number of dogs in the image; etc.).

Context information can include data corresponding to the environment of sensor node 101 (e.g. time, weather, illumination, etc.). Context information and external parameters can be provided to the sensor node via a context interface 149. Optionally, context interface 149 can comprise at least one sensor configured to gather context information. In some examples, output data can be generated in accordance with context information. For example, if context information indicates that lighting conditions are relatively low, then one or more infra-red (IR) lights are turned on in order to assist in capturing sensor data. As another example, if context information indicates that a certain event, e.g. a football match, has begun or ended, then the sensor node performs face detection.

Each predicted request specifies at least one parameter corresponding to the output data as predicted to be desired. As will be further detailed with reference to FIGS. 3-9, processor and memory block 102 is further configured to automatically reconfigure operation of sensor node 101 based on at least one parameter specified in the predicted request. Likewise, for an incoming request, reconfiguring can include, for example: selecting a utility from among the multiple predefined utilities stored in a memory of the sensor node 101 for processing sensor data, configuring at least one sensor, and/or configuring buffering operations. Processor and memory block 102 is configured to use at least one selected utility to configure generation of predicted output data usable by an incoming request, as well as to define required sensing and storing configuration.

Similar to an incoming request, the at least one parameter specified in the predicted request can be, for example: data indicative of a priority ranking of the predicted request; data indicative of predicted output data to be desired; data indicative of the destination of the output data generated in accordance with the predicted request; etc.

In some examples, sensor node 101 can serve a single request, predicted or incoming, at a time. In other examples, sensor node 101 is capable of serving multiple concurrent requests, predicted and/or incoming, at substantially the same time concurrently.

Optionally, predicted requests corresponding to a certain mode of generating output data can be generated and served based on concurrent requests corresponding to other modes that are being served in parallel. For example, if an incoming request corresponding to processing visual sensor data is being served, then a concurrent predicted request corresponding to processing audio sensor data can be generated and served in parallel.

As will be further detailed with reference to FIGS. 2-9, processor and memory block 102 can be configured to execute several functional modules in accordance with computer-readable instructions implemented on a non-transitory computer-readable storage medium. Such functional modules are referred to hereinafter as comprised in the processor and memory block. Processor and memory block 102 can comprise a machine learning block 103 configured to generate a predicted request, and a management block 123 configured to serve at least one request (incoming, and/or, predicted).

Machine learning block 103 includes a pre-processor 105 operatively connected to a local database 107 and a predicted request generation module 108.

Pre-processor 105 is configured to prepare the incoming data to be used by local database 107 and predicted request generation module 108. Pre-processor 105 can perform at least one of, for example: data cleansing, filtering, transformation, etc. Alternatively, at least part of the functions of pre-processor 105 can be provided by at least one component (not shown) that is external to processor and memory block 102.

Predicted request generation module 108 includes a machine learning module 109 and a request model 111.

Machine learning module 109 is configured to access and use historic requests (incoming and/or predicted) to generate and update request model 111. Request model 111 can be stored in memory and accessed by machine learning module 109. As an example, request model 111 can be stored on local database 107 and/or buffer 153.

Predicted request generation module 108 is configured to use request model 111 to generate predicted requests.

Machine learning block 103 is operatively connected to management block 123.

Management block 123 is configured to manage operation of sensor node 101 to generate and store output data, e.g., externally requested output data resulting from incoming requests and/or predicted output data resulting from predicted requests.

Management block 123 is further configured to generate commands. Each command defines at least one utility to be selected from among the predefined utilities. Generated commands can be executed by elements of the sensor node (e.g., sensor interface 141, execution engine 143, and buffer 153) to generate and/or store predicted output data and/or output data specified by at least one incoming request.

Management block 123 includes a management module 125 operatively connected to a sensing mapper 127, processing mapper 129, and storage mapper 131.

Management module 125 is configured to generate general specifications corresponding to at least one request.

Sensing mapper 127, processing mapper 129, and storage mapper 131, are configured to generate customized specifications based on the general specifications as well as, optionally, device parameters. The customized specification(s) specifies the command(s) to be generated and, respectively, utility(s) to be selected.

Sensing mapper 127, processing mapper 129, and storage mapper 131 are operatively connected to sensor interface 141, execution engine 143, and buffer 153, respectively.

Sensor interface 141 and/or sensor(s) 147 are configured to use the customized sensing specification(s) to execute at least one utility for adjusting at least one configuration or capability of the sensor(s) 147 for generating output data.

Execution engine 143 is configured to use the customized processing specification(s) to execute at least one utility to generate processed output data.

Buffer 153 is configured to use the customized buffering specification(s) to execute at least one utility and buffer the data accordingly.

Management block 123 is further configured to output data requested in the incoming requests received from network 161. If an incoming request corresponds to a predicted request, then the predicted output data will be output in response to the incoming request according to at least one parameter of the incoming request.

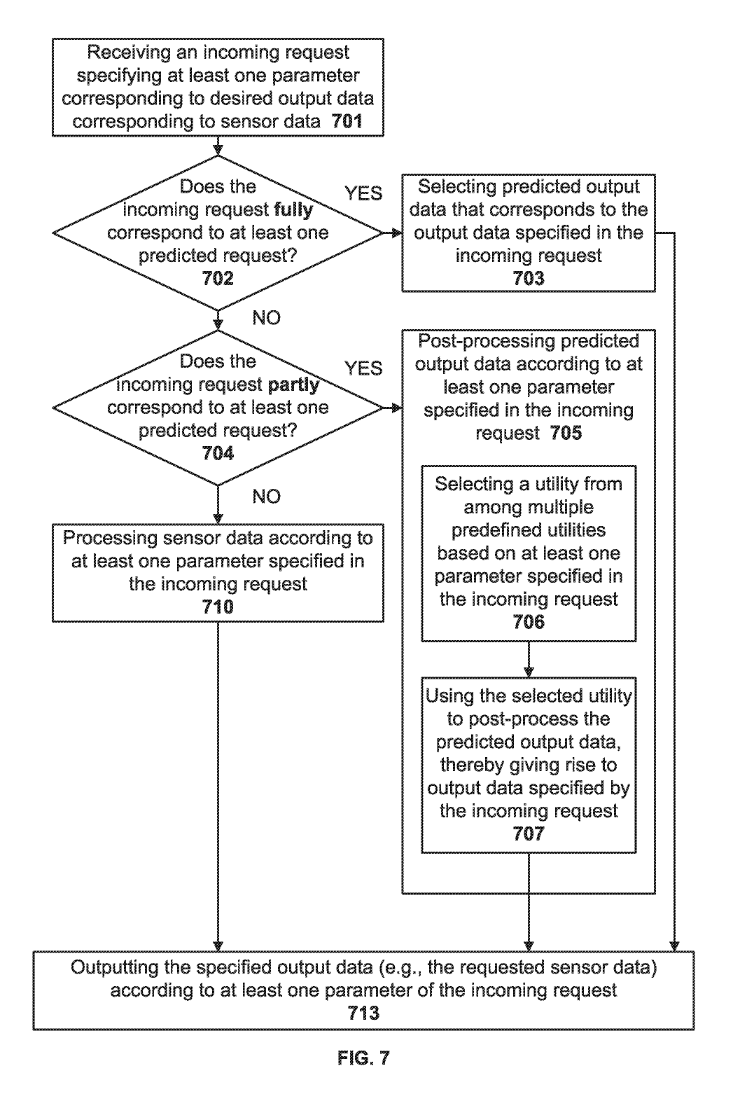

Post-processor 150 can be configured to further transform predicted output data into output data specified by incoming requests. Post-processor 150 allows for the serving of an incoming request that does not fully correspond to a predicted request, but does partly correspond thereto. As will be further detailed with reference to FIG. 7, if an incoming request only partly corresponds to a predicted request, then post-processor 150 is configured to post-process predicted output data according to at least one parameter of the incoming request so as to fit the specified output data.

In some examples, post-processor 150 receives commands instructing how to post-process the predicted output data from management module 125, processing mapper 129, and/or a post-processing mapper (not shown).

In some examples, if the incoming request does not even partly correspond to a predicted request, then sensor data can be processed and output according to at least one parameter of the incoming request.

It is noted that the teachings of the presently disclosed subject matter are not bound by sensor node 101 described with reference to FIG. 2. Equivalent and/or modified functionality can be consolidated or divided in another manner and can be implemented in any appropriate combination of software with firmware and/or hardware and executed on a suitable device. For example, management module 125 can include the functionality of at least one of the separate mappers 127, 127, 131, and/or, separate mappers can be consolidated.

Referring to FIGS. 3-9, there are illustrated generalized flow charts of operations in accordance with certain examples of the presently disclosed subject matter.

It is noted that the teachings of the presently disclosed subject matter are not bound by the flow charts illustrated in FIGS. 3-9, and the illustrated operations can occur out of the illustrated order. For example, operations 401-405 shown as being executed substantially concurrently can be executed in succession (in any appropriate order). It is also noted that while the flow charts are described with reference to elements of sensor node 101, this is by no means binding, and the operations can be performed by elements other than those described herein.

FIG. 3 illustrates a generalized flow-chart of operating a sensor node, in accordance with certain examples of the presently disclosed subject matter.

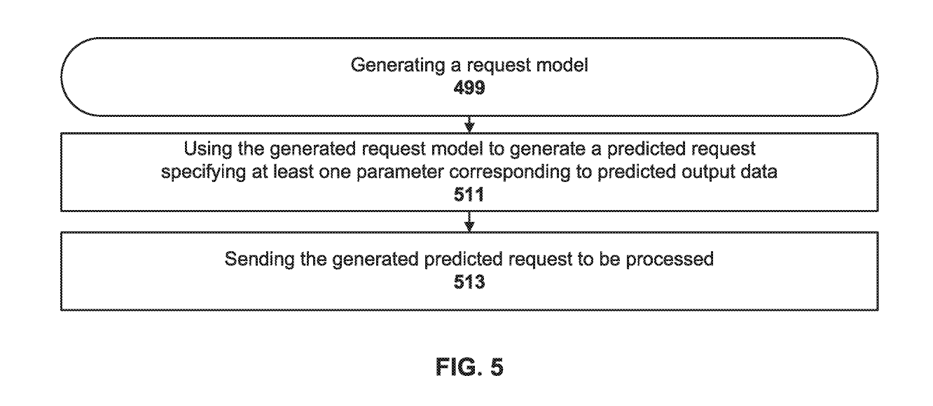

Operating includes generating (301) a predicted request specifying at least one parameter. Examples of this at least one parameter were detailed with reference to FIG. 2. Processor and memory block 102 (e.g. using machine learning block 103), generates a predicted request specifying at least one parameter thereof. An example of generating (301) a predicted request will be described below with reference to FIG. 5.

The generating of a predicted request can be triggered responsive to at least one predefined trigger as, for example: predefined period of absence of any incoming request; predefined period of absence of any predicted request; predefined period of absence of a request for a certain predefined mode of sensor node 101 (e.g., providing audio output data); sensor data (e.g., the sensing of a certain object and/or part of an object); context (e.g., time of day, weather); external parameters; state & content information of the buffer; a slot in a timing schedule; feedback information (described in detail below); etc.

In some examples, sensor node 101 can generate a predicted request at random, for example, chosen from the available utilities comprised in the sensor node.

For example, sensor node 101 can generate a predicted request at random, hereinafter, “random predicted request”, if the conditions to generate a non-random predicted request are not sufficient. As a non-limiting example, a condition for generating a random predicted request can be: if the sensor node is starting up for the first time (initialized), and/or re-initialized for some reason (e.g., no data to act upon is available), and no default behaviour is defined, then a random predicted request is generated.

In some examples, sensor node 101 can be configured to generate different random predicted requests at disproportionate rates. For example, sensor node 101 might be configured to generate a random predicted request for output data produced using face recognition 75% of the time that a random predicted request is desired and a random predicted request for output data produced using license plate recognition for the remaining 25% of the time.

In some examples, sensor node 101 can be configured to generate a default predicted request if no other predicted request can be generated, e.g. sensor node 101 will always generate a predicted request for output data produced using face recognition if no other predicted request can be generated. For example, when nothing else can be predicted since the conditions for producing a non-default predicted request are insufficient. As a non-limiting example, a condition for generating a default predicted request can be: if the sensor node is starting up for the first time (initialized), and/or re-initialized for some reason (e.g., no data to act upon is available), then a default predicted request is generated.

In some examples, the default predicted request can be generated based also on context information, e.g. if it is the day-time and/or there is daylight then generate a default predicted request for output data produced using face recognition if nothing else is predicted, and if it is night-time and/or it is dark out, then generate a default predicted request for output data produced using license plate recognition.

In some examples, sensor node 101 can be configured to generate random default predicted requests. For example, if it is the day-time and/or there is daylight then a random default predicted request for output data produced using face recognition will be generated 75% of the time and a random default predicted request for output data produced using license plate recognition will be generated the remaining 25% of the time, and, if it is night-time and/or it is dark out, then a random default predicted request for output data produced using license plate recognition will be generated 75% of the time and a random default predicted request for output data produced using face recognition will be generated the remaining 25% of the time.

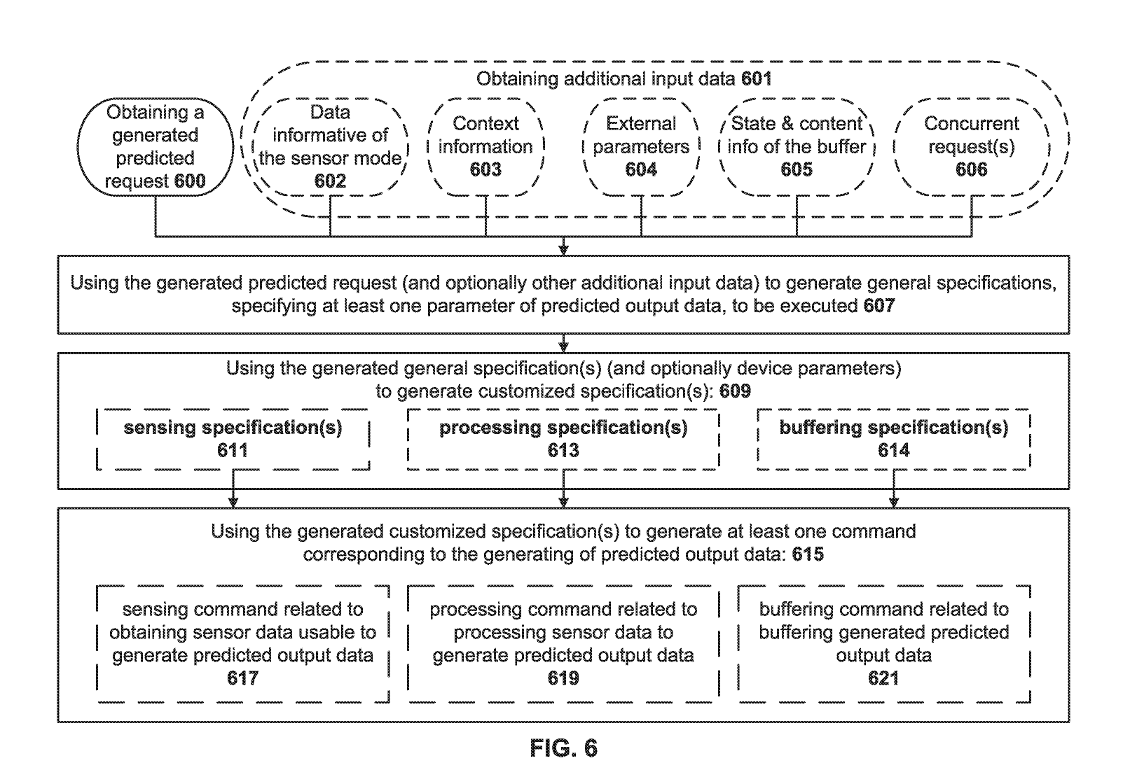

Upon generating (301) a predicted request, processor and memory block 102 (e.g. using management block 123) uses (303) the generated predicted request to generate at least one command. These commands define at least one utility to be selected from among the predefined utilities. Generated commands can be executed for the generating and/or storing of predicted output data. These commands specify, for example: obtaining sensor data usable to generate predicted output data; processing sensor data to generate predicted output data; buffering generated predicted output data; etc. An example of a process for serving a generated predicted request to generate at least one command will be described below with reference to FIG. 6.

Upon using (303) the generated predicted request to generate at least one command, sensor node 101 uses (305) the generated at least one command to select and execute at least one predefined utility, thus to generate and/or store predicted output data usable by further incoming requests.

Upon using (305) the generated predicted request to generate and/or store predicted output data, processor and memory block 102 (e.g. using management block 123) serves an incoming request and outputs (307) generated predicted output data corresponding to the predicted request. An example of a process for serving an incoming request and outputting (307) the generated predicted output data will be described below with reference to FIG. 7.

After the predicted request has been served and predicted output data has been generated and/or stored, then feedback information corresponding to the predicted output data can be obtained. This feedback information can be received from an external source (such as control station 110) responsive to the outputting of predicted output data. The feedback information can correspond to the accuracy of the predicted output data versus the desired output data that was specified in an incoming request that was determined as corresponding to the predicted request. As mentioned above, obtaining this feedback information can generate a trigger for generating at least one further predicted request. Optionally, in certain examples operation of the sensor node can be improved by the feedback loop. For example, if sensor node 101 receives feedback information that output data having a higher resolution was desired, then future predicted requests can generate predicted output data having a higher resolution.

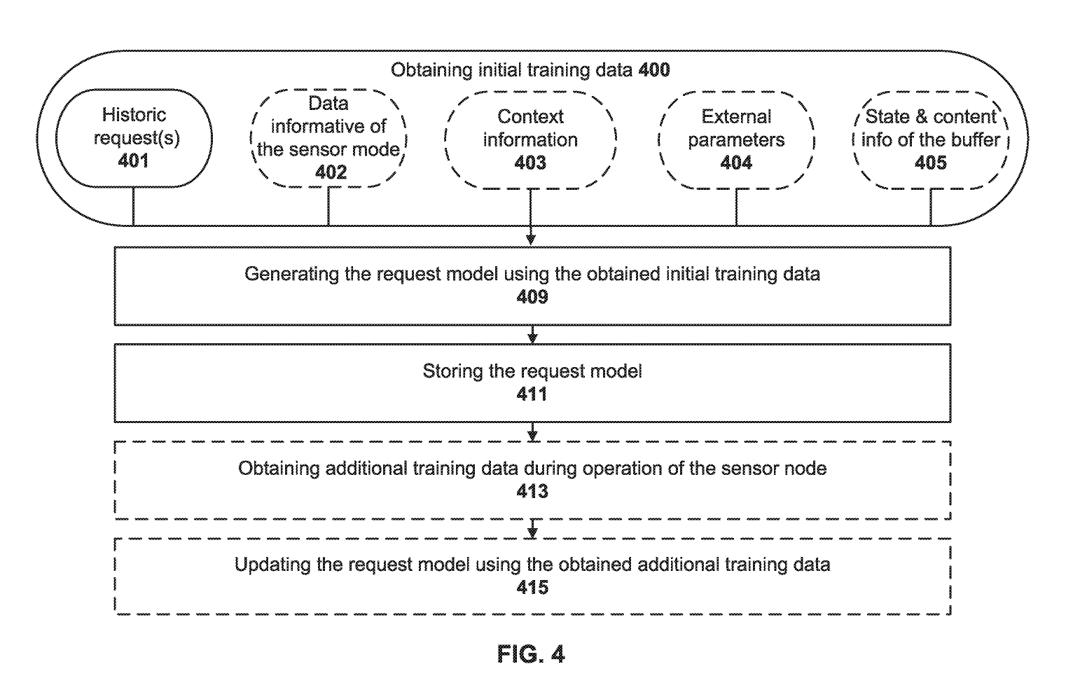

FIG. 4 illustrates a generalized flow-chart of generating a request model, in accordance with certain examples of the presently disclosed subject matter.

Prior to generating, processor and memory block 102 (e.g. using machine learning block 103) obtains (400) initial training data. Obtaining can include, for example: receiving from storage, receiving on-line, receiving from at least one module of the sensor node, etc.

Obtaining (400) initial training data can include obtaining (401) at least one historic request. Obtaining (400) initial training data can also include, for example: obtaining (402) data informative of the sensor mode, obtaining (403) context information, obtaining (404) at least one external parameter, obtaining (405) state and content information of the buffer, etc.

Optionally, upon obtaining (400) initial training data, processor and memory block 102 (e.g. using local database 107) stores the initial training data in the computer memory.

After the initial training data has been obtained (400) and optionally stored, processor and memory block 102 (e.g. using machine learning module 109) generates (409) a request model using the obtained initial training data.

Optionally, after the request model has been generated (409), processor and memory block 102 (e.g. using local database 107) stores (411) the generated request model 111 in computer memory. Alternatively, the request model does not have to be stored in the computer memory, rather, the request model can be loaded by the processor every time the request model is needed.

After the request model has been generated it can be updated as follows. After the request model has been stored (411), processor and memory block 102 (e.g. using machine learning block 103) obtains (413), and optionally stores, additional training data during operation of the sensor node. This obtaining (413) and storing can be done in a manner similar to that described above in relation to obtaining (400) and storing initial training data. Processor and memory block 102 (e.g. using machine learning module 109) then updates (415) the request model using the obtained additional training data and/or initial training data. Processor and memory block 102 (e.g. using local database 107) then stores the updated request model in the computer memory.

Additional training data can include, for example: historic requests (incoming and/or predicted); sensor data (and/or statistics thereof); data informative of the sensor mode; context information; external parameters; state & content information of the buffer; feedback information; etc.

For example, in a scenario where statistics of previously generated output data reveal that no face has been present in the output data of a sensor node for a year, but that there have been cars present in the output data, a request model that is not updated using those statistics might be used to generate a predicted request for output data resulting from face recognition, whereas a request model that is updated using those statistics would be used to generate a predicted request for output data resulting from license plate recognition.

Request model 111 can be updated responsive to at least one of the following update triggers, for example: serving at least one new incoming request; obtaining updated context information; generating at least one predicted request; serving at least one predicted request; obtaining sensor data; parallel executed processing or sensing; obtaining feedback information; etc. Updated context information can be obtained automatically and/or input manually (e.g. by an operator).

The updating of request model 111 can be at certain predetermined intervals, for example, once a day or once an hour. Alternatively or additionally, the updating of request model 111 can be continuous.

FIG. 5 illustrates a generalized flow-chart of generating a predicted request, in accordance with certain examples of the presently disclosed subject matter.

After processor and memory block 102 (e.g. using machine learning block 103) generates (499) and stores a request model, for example using the process described above in relation to FIG. 4, processor and memory block 102 receives/generates at least one trigger for generating a predicted request. Examples of these triggers were described in detail above in relation to FIG. 3. Alternatively, the sensor node can obtain a request model that was generated externally from processor and memory block 102, e.g. a request model that was generated by a different sensor node, a control station, any other appropriate device with a processor, etc. In some examples, the request model may be introduced during production of the sensor node and remain constant without any updates. Alternatively, the request model can be updated, as was described above, and/or replaced, e.g., in a maintenance cycle.

Responsive to the at least one trigger, processor and memory block 102 (e.g. using predicted request generation module 108) generates (511) a predicted request. The generated predicted request specifies at least one parameter corresponding to predicted output data. Examples of this at least one parameter were detailed with reference to FIG. 2.

After the predicted request has been generated, processor and memory block 102 (e.g. using machine learning block 103) then sends (513) the generated predicted request to be served. An example of serving the generated predicted request will be described below with regard to FIG. 6.

FIG. 6 illustrates a generalized flow-chart of serving a predicted request, in accordance with certain examples of the presently disclosed subject matter. The operations of the flow-chart of FIG. 6 are described in the context of serving a predicted request but are similarly applicable for serving an incoming request from a network, mutatis mutandis. As mentioned above, in some examples multiple concurrent requests (incoming and/or predicted), can be served substantially simultaneously in parallel.

Prior to serving, processor and memory block 102 (e.g. using management block 123) obtains (600) a generated predicted request (e.g. sent from machine learning block 103). An example of a process for generating a predicted request was described above with reference to FIG. 5.

Referring back to FIG. 6, optionally, processor and memory block 102 (e.g. using management block 123) obtains (601) additional input data. Obtaining (601) additional input data can include, for example: obtaining (602) data informative of the current mode of sensor node, obtaining (603) context information, obtaining (604) external parameters, obtaining (605) state and content information of the buffer, obtaining (606) at least one concurrent request (incoming and/or predicted), etc.

Once a generated predicted request and, optionally, additional input data has been obtained, processor and memory block 102 (e.g. using management module 125) uses (607) at least one parameter of the generated predicted request, and, optionally, the additional input data to generate general specification(s) to be executed. The general specification(s) specify at least one parameter of predicted output data.

After the general specification(s) has been generated, processor and memory block 102 (e.g. using sensing mapper 127, processing mapper 129, and storage mapper 131) uses (609) the general specification(s), and, optionally, device parameters to generate at least one customized specification.

The general specification(s) can be done for specifications that are common for the different predefined functions (e.g. those relating to sensing, processing, and buffering), to better manage and conserve time spent on serving the predicted request. Instead of doing the same specifications several separate times (for example, for sensing, processing, and buffering), the common specifications can be done at once for the different capabilities. Alternatively, the separate specifications can be generated without first generating general specification(s).

Generating at least one customized specification using (609) the general specification(s) and device parameters can further include, for example: using (611) the general specification(s) together with parameters, configurations, and capabilities of the sensor node to generate at least one sensing specification, using (613) the general specification(s) together with parameters, configurations, and capabilities of the sensor node to generate at least one processing specification, using (614) the general specification(s) together with the state of the buffer and the content of the buffer to generate at least one buffering specification, etc.

After the customized specification(s) have been generated, processor and memory block 102 (e.g. using management block 123) uses (615) the customized specification(s) to generate at least one command defining at least one utility to be selected. The generated command(s) can be executed for the generating of predicted output data. This at least one command can include at least one specific instruction and/or code for implementation (e.g. usable by sensor interface 141, execution engine 143, and/or buffer 153). For example, a customized specification can specify a certain mode of operation (e.g., obtain color video at a certain resolution) and the command can include more exact specifications (e.g., sensor #2, mode #3, pin #5).

Using (615) the at least one customized specification to generate at least one command defining at least one utility to be selected can further include, for example: generating (617) a sensing command defining at least one utility to be selected for executing and obtaining sensor data usable to generate predicted output data, generating (619) a processing command defining at least one utility to be selected for executing processing sensor data to generate predicted output data, generating (621) a buffering command defining at least one utility to be selected for executing buffering generated predicted output data, etc.

FIG. 7 illustrates a generalized flow-chart of using a generated predicted request for serving an incoming request, in accordance with certain examples of the presently disclosed subject matter.

Serving includes receiving (701) an incoming request. Processor and memory block 102 (e.g. management module 125) receives an incoming request. The incoming request specifies at least one parameter corresponding to desired output data corresponding to sensor data.

Upon receiving (701) an incoming request, processor and memory block 102 checks (702) whether the incoming request corresponds to a generated predicted request. If the incoming request corresponds to a generated predicted request, then processor and memory block 102 selects (703) predicted output data that corresponds to the output data specified in the incoming request (based on at least one parameter specified in the incoming request). Then sensor node 101 outputs (713) the specified output data according to at least one parameter of the incoming request.

Correspondence between an incoming request and predicted request(s) can be checked by comparing parameter(s) specified in the incoming request to parameter(s) in the predicted request(s), and/or, by comparing output data specified in the incoming request to predicted output data.

Optionally, upon receiving (701) an incoming request, processor and memory block 102 checks (702) whether the incoming request fully corresponds to a generated predicted request. This checking of whether or not there is correspondence can be performed, for example, using a lookup table.

If the incoming request fully corresponds to a generated predicted request, then processor and memory block 102 selects (703) and outputs (713) the specified output data, as described above.

If the incoming request does not fully correspond to a predicted request, then processor and memory block 102 checks (704) whether the incoming request partly corresponds to a predicted request (e.g., using a lookup table).

If the desired output data partly corresponds to generated predicted output data, then processor and memory block 102 (e.g., using post-processor 150) post-processes (705) generated predicted output data according to at least one parameter specified in the incoming request to generate output data specified by the incoming request. For example, in cases where the incoming request only partly corresponds to a previous predicted request, the predicted output data can be post-processed to more fully correspond to the output data specified in the incoming request.

Post-processing (705) the generated predicted output data according to at least one parameter of the incoming request can further include, for example: selecting (706) at least one utility from among multiple predefined utilities based on at least one parameter specified in the incoming request, and using (707) the selected utility(s) to post-process the generated predicted output data, thereby giving rise to output data specified by the incoming request.

For example, in a case where the predicted request does not fully correspond to the incoming request, but does partly correspond to the incoming request, then the predicted output data generated by the predicted requested can be transformed into the output data requested in the incoming request. As an example, if the prediction was for a coloured image of a face and the incoming request is for a black & white picture of that very face, then a black & white transformation of the coloured picture can be performed to meet the incoming request, thereby taking advantage of the already conducted face detection and recognition initiated by the predicted request.

Upon post-processing (705), processor and memory block 102 outputs (713) the specified output data according to at least one parameter of the incoming request.

If, when processor and memory block 102 checks (704) whether the incoming request partly corresponds to a predicted request, the incoming request does not even partly correspond to a predicted request, then processor and memory block 102 processes (710) sensor data.

Upon processing (710) sensor data, processor and memory block 102 outputs (713) the specified output data.

As such, in some examples, if there is no generated predicted output data that even partly corresponds to the incoming request, then the incoming request can be answered by processing sensor data to generate desired output data and outputting the generated desired output data.

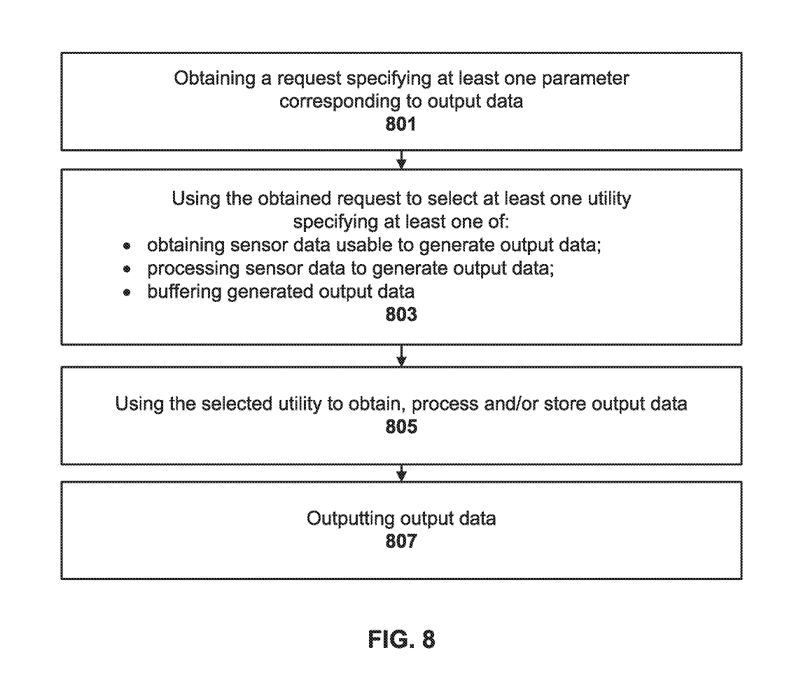

FIG. 8 illustrates a generalized flow-chart of operating a sensor node, in accordance with certain examples of the presently disclosed subject matter.

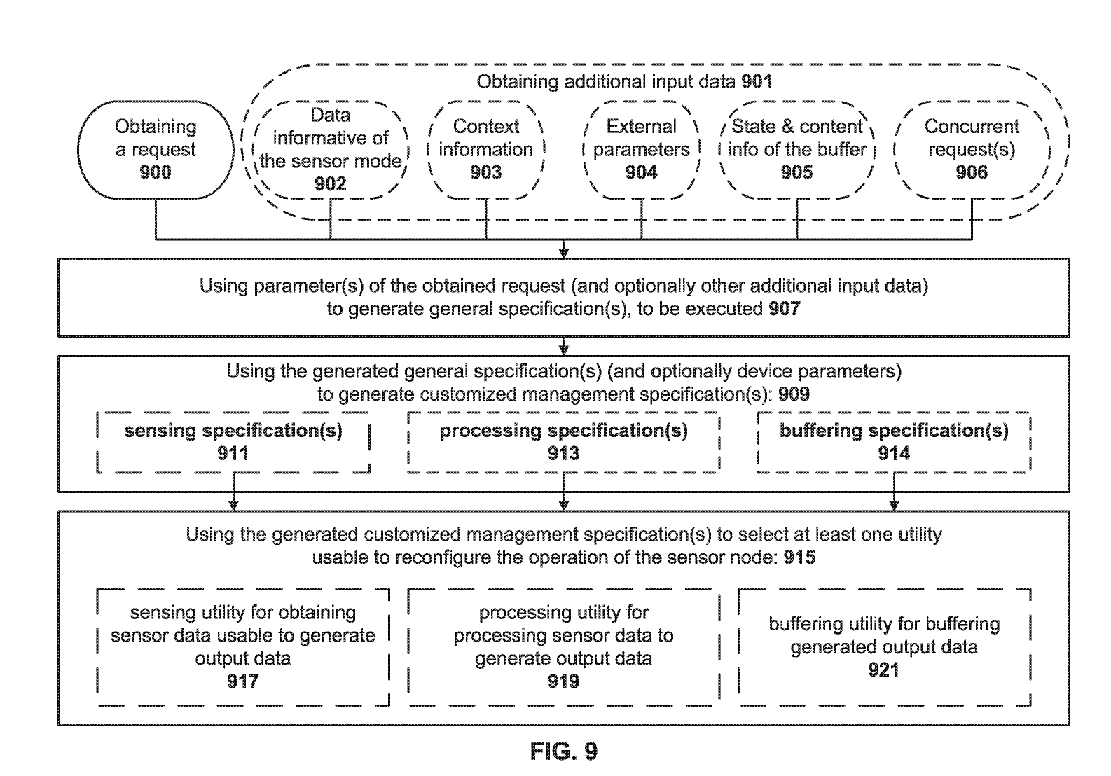

Upon obtaining (801) a request (incoming and/or predicted), processor and memory block 102 (e.g., using management block 123) uses (803) the obtained request to select at least one utility specifying at least one of, for example: obtaining sensor data usable to generate output data, processing sensor data to generate output data, buffering generated output data, etc. An example of a process for serving an obtained request to select at least one utility and reconfigure the operation of the sensor node will be described below with reference to FIG. 9.

Upon using (803) the obtained request to select at least one utility, sensor node 101 uses (805) the selected utility(s) to obtain, process and/or store output data. Using (805) the selected utility(s) gives rise to output data usable by further incoming requests.

Upon using (805) the selected utility(s), processor and memory block 102 (e.g. using management block 123) outputs (807) generated output data.

FIG. 9 illustrates a generalized flow-chart of serving a request, in accordance with certain examples of the presently disclosed subject matter. The operations of the flow-chart of FIG. 9 are similarly applicable for serving an incoming request and/or a predicted request. As mentioned above, in some examples multiple concurrent requests (incoming and/or predicted) can be served substantially simultaneously, in parallel.

In addition to obtaining (900) a request by processor and memory block 102 (e.g. using management block 123), processor and memory block 102 obtains (901) additional input data. Obtaining (901) additional input data can include, for example: obtaining (902) data informative of the current mode of sensor node, obtaining (903) context information, obtaining (904) at least one external parameter, obtaining (905) state and content information of the buffer, obtaining (906) at least one concurrent request, etc.

Once a request and, optionally, additional input data has been obtained, processor and memory block 102 (e.g. using management module 125) uses (907) parameters of the obtained request, and, optionally the obtained additional input data to generate general specification(s) to be executed based on at least one parameter specified in the obtained request.

After the general specification(s) have optionally been generated, processor and memory block 102 (e.g. using sensing mapper 127, processing mapper 129, and storage mapper 131) uses (909) the general specification(s) and device parameters to generate customized specifications.

As mentioned above, the general specification(s) can be generated for specifications that are common for the different predefined functions. Alternatively, the process can be done without first generating general specification(s).

In some examples, the general specification(s) are sufficient and there is no need to generate customized specification(s).

Generating customized specification(s) using (909) the general specification(s) and device parameters can further include, for example: using (911) the general specification(s) together with parameters, configurations, and capabilities of the sensor node to generate customized sensing specifications, using (913) the general specification(s) together with parameters, configurations, and capabilities of the sensor node to generate customized processing specifications, using (914) the general specification(s) together with the state of the buffer and the content of the buffer to generate customized buffering specifications, etc.

After the customized specifications have been generated, sensor node 101 uses (915) the customized specification(s) to select at least one utility usable to reconfigure the operation of the sensor node. This at least one utility is executable, for example, by sensor interface 141, execution engine 143, and/or buffer 153.

Using (915) the customized specifications to select at least one utility usable to reconfigure the operation of the device can also further include, for example: selecting (917) a utility for obtaining sensor data usable to generate output data, selecting (919) a utility for processing sensor data to generate output data, selecting (921) a utility for buffering generated output data, etc.

The invention described in detail above can alleviate issues of data transmission, processing and storage for networks that deal with relatively large amounts of sensor data (e.g. video surveillance networks).

Furthermore, the invention can be used to address certain issues of privacy that are evident when dealing with an automated and large scale collection of data.

It is to be understood that the invention is not limited in its application to the details set forth in the description contained herein or illustrated in the drawings. The invention is capable of other examples and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the examples of the invention as hereinbefore described without departing from its scope, defined in and by the appended claims.

1. A method of operating a sensor network comprising a plurality of sensor nodes and at least one control station, each sensor node comprising a memory operatively connected to a processor and to at least one sensor, the method comprising:
generating, by a sensor node from among the plurality of sensor nodes, a predicted request specifying at least one parameter corresponding to predicted output data;
using by the sensor node the generated predicted request to select at least one utility from among a plurality of predefined utilities, wherein the selected utility is configured to execute at least one of predefined functions selected from the group consisting of functions related to obtaining by the sensor node sensor data usable to generate predicted output data, functions related to processing by the sensor node sensor data to generate predicted output data, and functions related to buffering at the sensor node generated predicted output data; and
using by the sensor node the selected at least one utility to generate predicted output data, thereby giving rise to predicted output data usable by an incoming request from the at least one control station when the incoming request corresponds to the predicted request.

2. The method of claim 1, wherein the at least one parameter of the predicted request is selected from the group consisting of:
data indicative of a priority ranking of the predicted request; data indicative of predicted output data; and data indicative of the destination of the output data generated in accordance with the predicted request.

3. The method of claim 1, wherein the predicted request is generated using data selected from a group consisting of data informative of:
historical data corresponding to a previously served incoming request; statistics of historical data corresponding to a previously served incoming request; historical data corresponding to a previously generated predicted request; statistics of historical data corresponding to a previously generated predicted request; historical data corresponding to matching between a previously generated predicted request and a respective served incoming request; statistics of historical data corresponding to matching between a previously generated predicted request and a respective served incoming request; a concurrent incoming request; context information; and at least one external parameter.

4. The method of claim 1, wherein generating the predicted request is provided using a request model, the request model built using at least one historic incoming request, and at least one of: context information; at least one external parameter; state of a buffer; content of a buffer; and feedback information.

5. The method of claim 4, wherein the request model is updated, by the sensor node, responsive to at least one of: serving at least one new incoming request; obtaining updated context information; generating at least one predicted request; serving at least one predicted request; obtaining sensor data; and obtaining feedback information.

6. The method of claim 1, further comprising outputting, by the sensor node, predicted output data responsive to an incoming request corresponding to the predicted request.

7. The method of claim 1, further comprising post-processing, by the sensor node, the predicted output data according to at least one parameter of the incoming request, when the predicted request only partly corresponds to the incoming request.

8. The method of claim 7, wherein post-processing further comprises selecting a utility from among multiple predefined utilities based on the at least one parameter of the incoming request; and using the selected utility to post-process the predicted output data, thereby giving rise to output data specified by the incoming request.

9. A sensor node in a sensor network comprising a plurality of sensor nodes and at least one control station, the sensor node comprising:
a memory operatively connected to a processor and to at least one sensor, wherein the processor is configured to:
generate a predicted request specifying at least one parameter corresponding to predicted output data;
use the generated predicted request to select at least one utility from among a plurality of predefined utilities, wherein the selected utility is configured to execute at least one of predefined functions selected from the group consisting of functions related to obtaining by the sensor node sensor data usable to generate predicted output data, functions related to processing by the sensor node sensor data to generate predicted output data, and functions related to buffering at the sensor node generated predicted output data; and
use the selected at least one utility to generate predicted output data, thereby giving rise to predicted output data usable by an incoming request from the at least one control station when the incoming request corresponds to the predicted request.

10. The sensor node of claim 9, wherein the at least one parameter of the predicted request is selected from the group consisting of:
data indicative of a priority ranking of the predicted request; data indicative of predicted output data to be desired; and data indicative of the destination of the output data generated in accordance with the predicted request.

11. The sensor node of claim 9, wherein the predicted request is generated using data selected from a group consisting of data informative of:
historical data corresponding to a previously served incoming request; statistics of historical data corresponding to a previously served incoming request; historical data corresponding to a previously generated predicted request; statistics of historical data corresponding to a previously generated predicted request; historical data corresponding to matching between a previously generated predicted request and a respective served incoming request; statistics of historical data corresponding to matching between a previously generated predicted request and a respective served incoming request; a concurrent incoming request; context information; and at least one external parameter.

12. The sensor node of claim 9, further comprising a request model built using at least one historic incoming request, and at least one of: context information; at least one external parameter; state of a buffer; and content of a buffer.

13. The sensor node of claim 12, wherein the request model is updated responsive to at least one of: serving at least one new incoming request; obtaining updated context information; generating at least one predicted request; serving at least one predicted request; and obtaining sensor data.

14. The sensor node of claim 9, wherein the processor is further configured to output predicted output data responsive to an incoming request corresponding to the predicted request.

15. The sensor node of claim 9, wherein the processor is further configured to post-process the predicted output data according to at least one parameter of the incoming request, when the predicted request only partly corresponds to the incoming request.

16. The sensor node of claim 15, wherein the processor is further configured to select a utility from among multiple predefined utilities based on the at least one parameter of the incoming request; and use the selected utility to post-process the predicted output data, thereby giving rise to output data specified by the incoming request.

17. A non-transitory program storage device readable by machine, tangibly embodying a program of instructions executable by the machine to perform a method of operating a sensor node in a sensor network comprising a plurality of sensor nodes and at least one control station, each sensor node comprising a memory operatively connected to a processor and to at least one sensor, the method comprising:
generating, by a sensor node from among the plurality of sensor nodes, a predicted request specifying at least one parameter corresponding to predicted output data;
using by the sensor node the generated predicted request to select at least one utility from among a plurality of predefined utilities, wherein the selected utility is configured to execute at least one of predefined functions selected from the group consisting of functions related to obtaining by the sensor node sensor data usable to generate predicted output data, functions related to processing by the sensor node sensor data to generate predicted output data, and functions related to buffering at the sensor node generated predicted output data; and
using by the sensor node the selected at least one utility to generate predicted output data, thereby giving rise to predicted output data usable by an incoming request from the at least one control station when the incoming request corresponds to the predicted request.

18. The non-transitory program storage device of claim 17, wherein the at least one parameter of the predicted request is selected from the group consisting of:
data indicative of a priority ranking of the predicted request; data indicative of predicted output data; and data indicative of the destination of the output data generated in accordance with the predicted request.

19. The non-transitory program storage device of claim 17, wherein the predicted request is generated using data selected from a group consisting of data informative of:
historical data corresponding to a previously served incoming request; statistics of historical data corresponding to a previously served incoming request; historical data corresponding to a previously generated predicted request; statistics of historical data corresponding to a previously generated predicted request; historical data corresponding to matching between a previously generated predicted request and a respective served incoming request; statistics of historical data corresponding to matching between a previously generated predicted request and a respective served incoming request; a concurrent incoming request; context information; and at least one external parameter.

20. The non-transitory program storage device of claim 17, wherein generating the predicted request is provided using a request model, the request model built using at least one historic incoming request, and at least one of: context information; at least one external parameter; state of a buffer; and content of a buffer.
